(19) United States
(12) Patent Application Publication
(10) Pub. No.: US 2022/0180056 A1
(43) Pub. Date: Jun. 9, 2022

(54) METHOD AND APPARATUS FOR TRANSLATION OF A NATURAL LANGUAGE QUERY TO A SERVICE EXECUTION LANGUAGE

(71) Applicant: HERE Global B.V., Eindhoven (NL)

(72) Inventor: Soojung HONG, Zurich (CH)

(21) Appl. No.: 17/116,744

(22) Filed: Dec. 9, 2020

(51) Int. Cl. G06F 40/211; G06F 40/30; G06N 20/00; G06F 9/54

(52) U.S. Cl. CPC G06F 40/211; G06F 9/547; G06N 20/00; G06F 40/30

(57) ABSTRACT

An approach is provided for directly translating a natural language query into machine executable commands. The approach involves parsing the natural language query into one or more phrases comprising one or more words of the natural language query. The approach further involves processing the one or more phrases using a machine learning model that extracts semantic relationship information between the one or more words and uses the semantic relationship information to translate the one or more phrases directly into one or more machine executable commands, one or more parameters of the one or more machine executable commands, or a combination thereof. The approach further involves providing one or more machine executable commands, the one or more parameters, or a combination thereof as an output.

### BACKGROUND

Service providers are continually challenged to improve the interaction experience between their services (e.g., location-services such as mapping and navigation) and end users. One active area of development is the use of natural language queries or other inputs (e.g., queries or inputs expressed in a user's language without special syntax or format adapted to a service) to interface with services and applications. The task of converting or translating natural language queries into a service execution language (e.g., machine executable code) presents significant technical challenges and have been traditionally complex and resource intensive, often requiring extensive post-processing of the generated service execution code to ensure proper execution.

### SOME EXAMPLE EMBODIMENTS

Therefore, there is a need for an approach for translating natural language queries or inputs to a service execution language while eliminating or otherwise minimizing post-processing of the code results.

According to one embodiment, a method comprises parsing the natural language query (or other natural language input) into one or more phrases respectively comprising one or more words of the natural language query. The method also comprises processing the one or more phrases using a machine learning model (e.g., a self-attention based neural network such as a Transformer) that extracts semantic relationship information between the one or more words and uses the semantic relationship information to translate the one or more phrases directly into one or more machine executable commands, one or more parameters of the one or more machine executable commands, or a combination thereof (e.g., comprising a service execution language). The method further comprises providing one or more machine executable commands, the one or more parameters, or a combination thereof as an output. In addition or alternatively to providing the output, the method may further comprise initiating an execution of the one or more machine executable commands using the one or more parameters to generate a query result and then providing the query result in response to the natural language query.

According to another embodiment, an apparatus comprises at least one processor, and at least one memory including computer program code for one or more computer programs, the at least one memory and the computer program code configured to, with the at least one processor, cause, at least in part, the apparatus to parse the natural language query (or other natural language input) into one or more phrases respectively comprising one or more words of the natural language query. The apparatus is also caused to process the one or more phrases using a machine learning model (e.g., a self-attention based neural network such as a Transformer) that extracts semantic relationship information between the one or more words and uses the semantic relationship information to translate the one or more phrases directly into one or more machine executable commands, one or more parameters of the one or more machine executable commands, or a combination thereof (e.g., comprising a service execution language). The apparatus is further caused to provide one or more machine executable commands, the one or more parameters, or a combination thereof as an output. In addition or alternatively to providing the output, the apparatus may be further caused to initiate an execution of the one or more machine executable commands using the one or more parameters to generate a query result and then to provide the query result in response to the natural language query.

According to another embodiment, a computer-readable storage medium carries one or more sequences of one or more instructions which, when executed by one or more processors, cause, at least in part, an apparatus to parse the natural language query (or other natural language input) into one or more phrases respectively comprising one or more words of the natural language query. The apparatus is also caused to process the one or more phrases using a machine learning model (e.g., a self-attention based neural network such as a Transformer) that extracts semantic relationship information between the one or more words and uses the semantic relationship information to translate the one or more phrases directly into one or more machine executable commands, one or more parameters of the one or more machine executable commands, or a combination thereof (e.g., comprising a service execution language). The apparatus is further caused to provide one or more machine executable commands, the one or more parameters, or a combination thereof as an output. In addition or alternatively to providing the output, the apparatus may be further caused to initiate an execution of the one or more machine executable commands using the one or more parameters to generate a query result and then to provide the query result in response to the natural language query.

According to another embodiment, an apparatus comprises means for parsing the natural language query (or other natural language input) into one or more phrases respectively comprising one or more words of the natural language query. The apparatus also comprises means for processing the one or more phrases using a machine learning model (e.g., a self-attention based neural network such as a Transformer) that extracts semantic relationship information between the one or more words and uses the semantic relationship information to translate the one or more phrases directly into one or more machine executable commands, one or more parameters of the one or more machine executable commands, or a combination thereof (e.g., comprising a service execution language). The apparatus further comprises means for providing one or more machine executable commands, the one or more parameters, or a combination thereof as an output. In addition or alternatively to providing the output, the apparatus may further comprise means for initiating an execution of the one or more machine executable commands using the one or more parameters to generate a query result and then means for providing the query result in response to the natural language query.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of translating a natural language query to a service execution language, according to one example embodiment;

FIG. 2 is a diagram illustrating an example of a natural language query that is converted to a location service call command, according to one embodiment;

FIG. 3 is a diagram of the components of a parsing platform and/or parsing application capable of translating a natural language query to a service execution language, according to one example embodiment;

FIG. 4 is a flowchart of a process for translating a natural language query to a service execution language, according to one example embodiment;

FIG. 5 is a diagram illustrating an example natural language query and a list of phrases parsed from the query, according to one embodiment;

FIG. 6 is a diagram illustrating an example syntactic parse tree determined from a natural language query, according to one embodiment;

FIG. 7 is a diagram illustrating an example of a constituent tag hierarchy for a syntactic parse tree, according to one embodiment;

FIG. 8 is a diagram illustrating an example sequence of query phrases and a corresponding sequence of semantic labels, according to one embodiment;

FIG. 9 is a diagram illustrating an example machine learning architecture (e.g., a Transformer model) capable of translating a natural language query to a service execution language, according to one embodiment;

FIG. 10 is a diagram illustrating an example Transformer as an encoder-decoder model and examples of input and output sequences, according to one embodiment;

FIG. 11 is a diagram illustrating an example of query semantic parsing and service call translation, according to one embodiment;

FIG. 12 is a diagram illustrating an intent-slot based execution framework, according to one embodiment;

FIG. 13 is a diagram of a geographic database, according to one embodiment;

FIG. 14 is a diagram of hardware that can be used to implement an embodiment of the processes described herein;

FIG. 15 is a diagram of a chip set that can be used to implement an embodiment of the processes described herein; and

FIG. 16 is a diagram of a terminal that can be used to implement an embodiment of the processes described herein.

### DESCRIPTION OF SOME EMBODIMENTS

Examples of a method, apparatus, and computer program for translating a natural language query or input to a service execution language are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

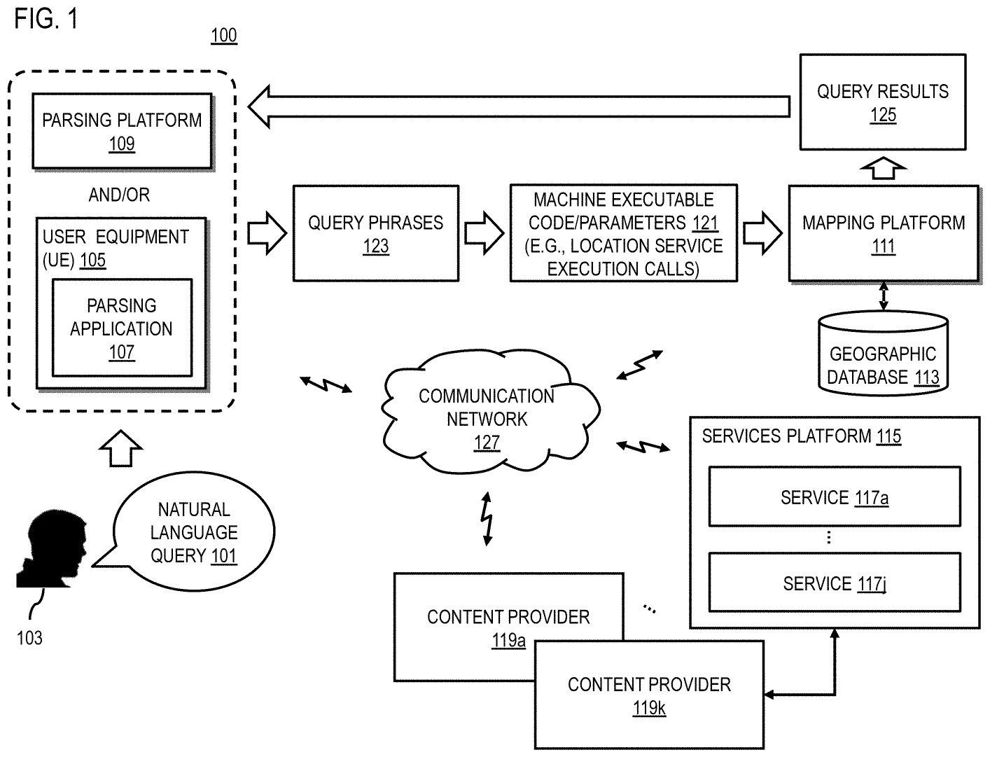

FIG. 1 is a diagram of a system 100 capable of translating a natural language query to a service execution language, according to one example embodiment. Historically, users have needed to adapt to the interaction capabilities of a computerized system for the system to comprehend their requests. Introducing natural language interaction capabilities to various services or applications such as, but not limited to, location-based services (e.g., mapping, navigation, routing, etc.) has significantly simplified the interaction between users and these services and applications. By way of example, a natural language query or input 101 is provided (e.g., via speech or text by a user 103) in a language used by a human user (as opposed to a computer language or other artificial language), including all of the idioms, assumptions and implications of an utterance.

For example, the natural language query 101 can be captured from the user 103 by a user equipment (UE) device 105 (e.g., via a microphone sensor or other input device) and then processed locally by a parsing application 107 executing on the UE 105 or processed remotely by a parsing platform 109 alone or in combination with the parsing application 107. The parsing application 107 and/or parsing platform 109 may process the natural language query 101 to determine the meaning of the query 101 such that the natural language query 101 can be “understood” and/or acted on by one or more services or applications such but not limited to location services (e.g., mapping services, navigation services, etc.) of a mapping platform 111 in combination with a geographic database 113 (e.g., comprising digital map data records). In addition or alternatively, the services or applications to which the natural language query 101 is directed can include third party services and applications such as, but not limited to, a services platform 115, one or more services 117a-117j (also collectively referred to as services 117) of the services platform 115, one or more content providers 119a-119k (also collectively referred to as content providers 119), and/or the like.

By way of example, the processing of the natural language query 101 can include a semantic query parsing task to identify semantic meanings of tokens (words) in the natural language queries 101. Traditionally, only a few individual token or words in a natural language query 101 are labeled with semantic tags. Therefore, the identified tokens and their semantic meanings are handled in a discrete manner, which does not convey any semantic relationship with the whole query sentence nor with other semantically relevant tokens. The lack of representing the semantic relationship between whole query sentence and each semantic token requires additional processing to be properly used in following natural language processing tasks. For instance, semantic parse result determined using individual tokens generally cannot be directly used to construct any service application programming interface (API) calls or application execution commands such as SQL or GraphQL (e.g., machine executable code and/or related parameters 121).

Semantic parsing technology has a long history of development. In early days, rule-based methods or statistical methods were dominant approaches. Later, machine learning methods such as Recurrent Neural Network and Encoder-Decoder model became popular methods. Typical types of semantic parsing tasks were token position identification in sentence such as finding a beginning of sentence (BOS) or end of sentence (EOS). Other types of semantic parsing involve identifying the Named-Entity objects.

The types of semantic parsing tasks described above often do not need to deal with large semantic labels set. Therefore, rule-based or statistical approach could work. However, recent natural language processing tasks need to identify more various and sophisticated semantic labels within text (e.g., such as sematic labels associated service execution languages associated with modern location-based and other types of services). Besides, the structural relationship between tokens and tokens' semantic meaning were hardly considered for use in building traditional semantic parsers (e.g., because of the reliance on labeling only individual tokens or words in the natural language query 101). The result from discrete token base semantic parsing inevitably leads to requiring post processing if the parse results are used. In other words, semantic results generated from individual tokens or words typically require additional processing to construct the corresponding API calls or commands, thereby increasing the complexity and resource requirement for processing natural language queries 101 into machine executable code. Accordingly, service providers face significant technical challenges with respect to directly translating a natural language query

To address these technical challenges, the system 100 of FIG. 1 introduces a capability to utilize the semantic dependency between query components (e.g., query phrases 123 comprising one or more words) for query parsing and to enable the direct translation from query parse result (e.g., the query phrases 123) to location service execution commands in according to the location service execution language (e.g., machine executable code and/or corresponding parameters for the code 121 such as location service execution calls and commands. In one embodiment, the system 100 is capable of training a machine learning model to translate a list of query phrases 123) parsed from a natural language query 101 to a list of semantic labels to each input phrase that constitute a service execution language. In this way, the system 100 can broaden the availability of services that enable the user to interact with the devices through natural language inputs without having to limit the user's verbiage to a limited set of commands, syntax, options, etc. Thereby enabling users to utilize everyday speech to communicate with their devices.

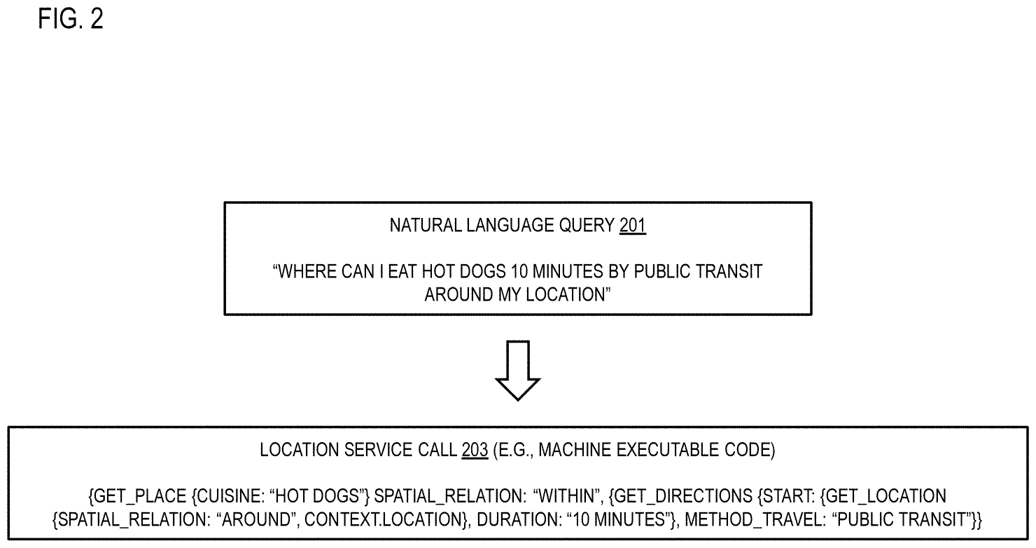

FIG. 2 is a diagram of the components of a mapping platform capable of translating a natural language query to a service execution language, according to one example embodiment. In the example of FIG. 2, a natural language query 201 is received as “Where can I eat hot dogs 10 minutes by public transit around my location.” This query 201 is considered a natural language query because the user provider the query 201 has stated the query using his natural language syntax and structure (e.g., English syntax and structure) without regard for any structure or format that might be required for execution by a service execution language (e.g., service API calls, commands, code, etc. and corresponding parameters) of a mapping service (e.g., a service of the mapping platform 111) to which the natural language query 201 is directed. Using the various embodiments described herein, the system 100 enables a direct translation of the natural language query 201 into a location service call 203 that, for instance, is machine executable code that can be executed by the service without further post-processing beyond the semantic parsing (e.g., translation) step. In this case, the natural language query 201 is directly translated to the following location service call 203:
{GET_PLACE {CUISINE: “HOT DOGS”} SPATIAL_RELATION: “WITHIN”, {GET_DIRECTIONS {START: {GET_LOCATION {SPATIAL_RELATION: “AROUND”, CONTEXT.LOCATION}, DURATION: “10 MINUTES”}, METHOD_TRAVEL: “PUBLIC TRANSIT”}}

As shown in the example above, in one embodiment, the system 100 (e.g., via the parsing platform 109 and/or parsing application 107) is a model that can translate the natural language queries 101 directly to machine executable commands or code/parameters 121 without requiring any postprocessing of the semantic parse result. By way of example, the natural language queries 101 that the system 100 tries to translate can include queries for location searches by map users (e.g., users of the mapping platform 111 and/or geographic database 113) or searches for data from the services platform 115, services 117, content providers 119, and/or the like. Under a location-based service use case, all possible location search questions are queries that the system 100 can handle.

Similarly, the target machine executable commands 121 can be location service commands (service API calls) that are used to send requests to location services such as search service, routing service, and any other location services. For example, a location-based search service can support a natural language user interface to accept voice commands or queries as illustrated in the example natural language query 201 of FIG. 2 above. The service commands or API calls are in a service execution language as illustrated in the location service call 203. On receiving the natural language 201, the location-based search service can use the parsing platform 109 according to the embodiments described herein to directly translate the natural language query 201 to the location service call 203. This location service call 203 can be executed by the location-based service to generate query results 125 (e.g., by using the location service call 203 to query the geographic database 113). The query results 125 can then be presented on an end user device (e.g., UE 105) that initiated the natural language query 201.

It noted that although the various embodiments described herein are discussed with respect to natural language queries 101, it is contemplated that the various embodiments are applicable to any type of natural language input (e.g., statements, commands, etc.) that can be translated into machine executable code/parameters 121.

The direct translation from semantic parse results (e.g., query phrases 123 parsed from a natural language query 101) to machine executable commands 121 is possible because the parsing results can convey the structural information (e.g., semantic relationships) of parsed query components (e.g., query phrases 123) within the original queries 101, and because the parsed semantics explicitly indicate machine executable command types and their argument types (e.g., command parameters). In other words, the direct translation can be based on the semantic relationship between parsed components and locational information within a parsed natural language query 101.

In one embodiment, the system 100 uses a machine learning model that follows the architecture of state-of-the art NLP (natural language processing) model called Transformer which is known for high performing language to language translation model (or any other equivalent translation model). The architecture of Transformer model, for instance, can be used to the relevant relationship between parsing components. Therefore, query components (e.g., query phrases 123) can contribute to semantic parsing by giving more information than a word or token. In other words, using query phrases 123 one or more words enables the system 100 to advantageously utilize more information to correctly identify the semantics behind the natural language queries 101. The semantics can then be used, in part, to translate the natural language queries 101 into machine executable code 121 (e.g., executable commands and parameters of a service execution language). The machine executable code 121 can then be executed (e.g., by the corresponding service) to generate query results 125 for transmission back to the querying entity.

One advantage of the various embodiments of the system 100 described herein is that the system 100 treats the semantic parsing job as not an intermediate subtask to achieve any final NLP task, rather the semantic parsing task itself serves as a language translation task to directly generate machine executable code 121 without any post-processing step after completion of the parsing task. In another embodiment, along with language translation aspect, based the performance of the system 100 when translating semantic labels (e.g., labels corresponding to machine executable commands and/or their parameters), the system 100 can be used as machine annotators for the annotation jobs that used to be done by human annotators.

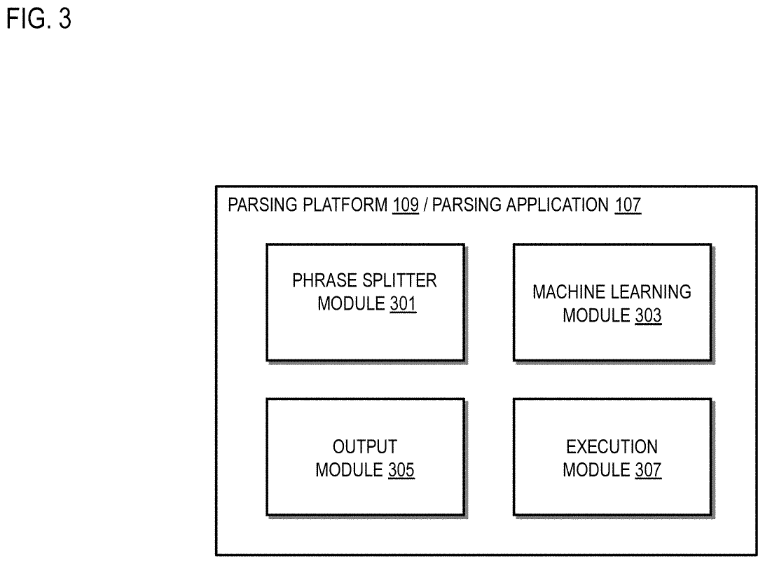

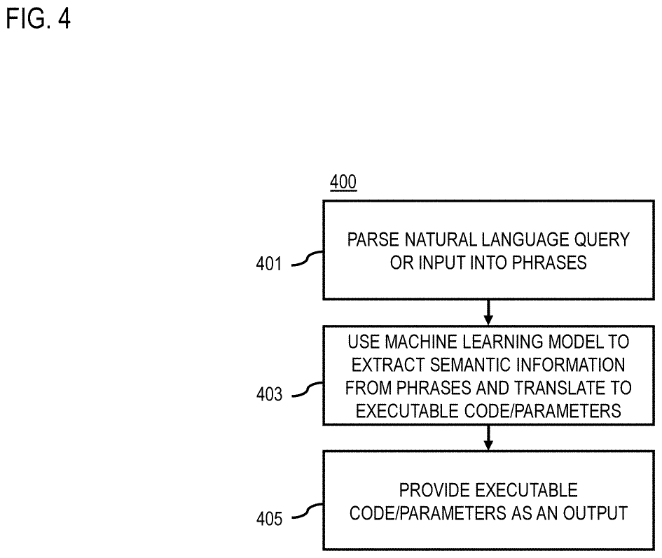

In one embodiment, as shown in FIG. 3, the parsing platform 109 and/or the parsing application 107 of the system 100 includes one or more components for translating a natural language query 101 to a service execution language (e.g., machine executable code and/or parameters 121) according to the various embodiments described herein. It is contemplated that the functions of the components of the parsing platform 109 and/or the parsing application 107 may be combined or performed by other components of equivalent functionality. As shown, in one embodiment, the parsing platform 109 and/or the parsing application 107 include a phrase splitter module 301, a machine learning module 303, an output module 305, and an execution module 307. The above presented modules and components of the parsing platform 109 and/or the parsing application 107 can be implemented in hardware, firmware, software, or a combination thereof. Though depicted as separate entities in FIG. 1, it is contemplated that the parsing platform 109 and/or the parsing application 107 may be implemented as a module of any of the components of the system 100 (e.g., a component of the mapping platform 111, services platform 115, services 117, content providers 119, and/or the like). In another embodiment, one or more of the modules 301-307 may be implemented as a cloud-based service, local service, native application, or combination thereof. The functions of the parsing platform 109, parsing application 107, and modules 301-307 are discussed with respect to FIGS. 4-13 below.

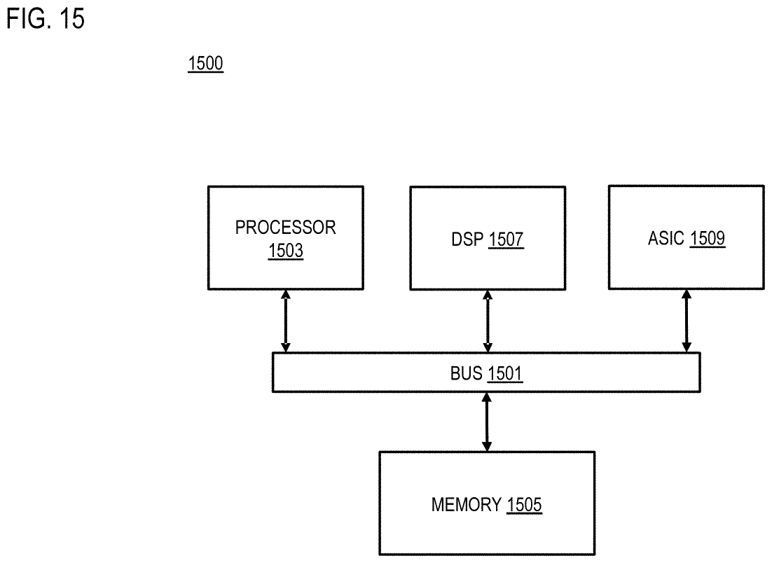

FIG. 4 is a flowchart of a process for translating a natural language query to a service execution language, according to one example embodiment. In various embodiments, the parsing platform 109, parsing application 107, and/or modules 301-307 may perform one or more portions of the process 400 and may be implemented in, for instance, a chip set including a processor and a memory as shown in FIG. 15. As such, the parsing platform 109, parsing application 107, and/or modules 301-307 can provide means for accomplishing various parts of the process 400, as well as means for accomplishing embodiments of other processes described herein in conjunction with other components of the system 100. Although the process 400 is illustrated and described as a sequence of steps, it is contemplated that various embodiments of the process 400 may be performed in any order or combination and need not include all of the illustrated steps.

Typically, the semantic parsing task is to identify semantic the meanings on some of the relevant words in text (e.g., in a natural language query 101). As described above, the parse results from a parsing process that relies only on extracting words individually (as opposed to phrases) generally need another proceeding task to be utilized in the whole natural language processing job to generated machine executable code. For this reason, the semantic parsing task traditionally has not been considered as language translation task which requires the complete output translation form (e.g., directly to completely machine execute code).

In contrast, the various of the embodiments of the process 400 described herein is based on interpreting the semantic parsing problem for natural language queries 101 as a language translation problem. For example, the language to be translated is natural language human queries (e.g., queries for searching locations on map) and the target output language is location service commands. As discussed above, FIG. 2 an example of location search query 201 and its corresponding translated output location service call command 203. The process 400 is described in the more detail below according to steps 401-405.

In step 401, the phrase splitter module 301 parses the natural language query into one or more phrases respectively comprising one or more words of the natural language query. The phrase splitter module 301 receives a natural language query 101 via a location-based application (e.g., mapping application) executing on a UE 105 that supports natural language input (e.g., via speech, typed text, etc.). For example, if the natural language query 101 is received as speech, a speech-to-text processor can be used to convert the spoken words of the query into text or other format supported for processing by the phrase splitter module 301.

The phrase splitter module 301 processes the input natural language query 101 to split the query 101 into a sequence of one or more query phrases 123. As described above, one aspect of the embodiments described herein for parsing is that the parsing component can be longer than a single token or word. Therefore, a phrase (e.g., a sequence of more than one token or word parsed from the natural language query 101) is the basic query parsing component. The use of query phrases 121 as opposed to words or tokens enables to the system 100 use the semantic or contextual relationships between words in the phrases and between the phrase themselves as additional information for translating the natural language query to a service execution language.

For example, a typical Encoder-Decoder model to translate languages use Recurrent Neural Network (RNN) as processing unit. Generally, the RNN is not capable of finding the relationship between individual or single tokens/words, rather the RNN proceeds with processing the individual tokens in sequence and produces an output accordingly. However, in one embodiment, the parsing platform 109 and/or parsing application 107 can use a natural language model such as, but not limited to, a Transformer model or equivalent. By way of example, the Transformer model has multiple Self-Attention units that can learn the semantic relationship between tokens or words. Thus, the phrase splitter module 301 can split the natural language query 101 into one or more phrases for the Transformer model or equivalent translation machine learning model to consume the phrases. In this way, the model can compare or determine the semantic or structural relationships between words of the query phrases 123 and between the different query phrases 123, and use the determine semantic/structural relationship information as more information than is carried by a single token or word.

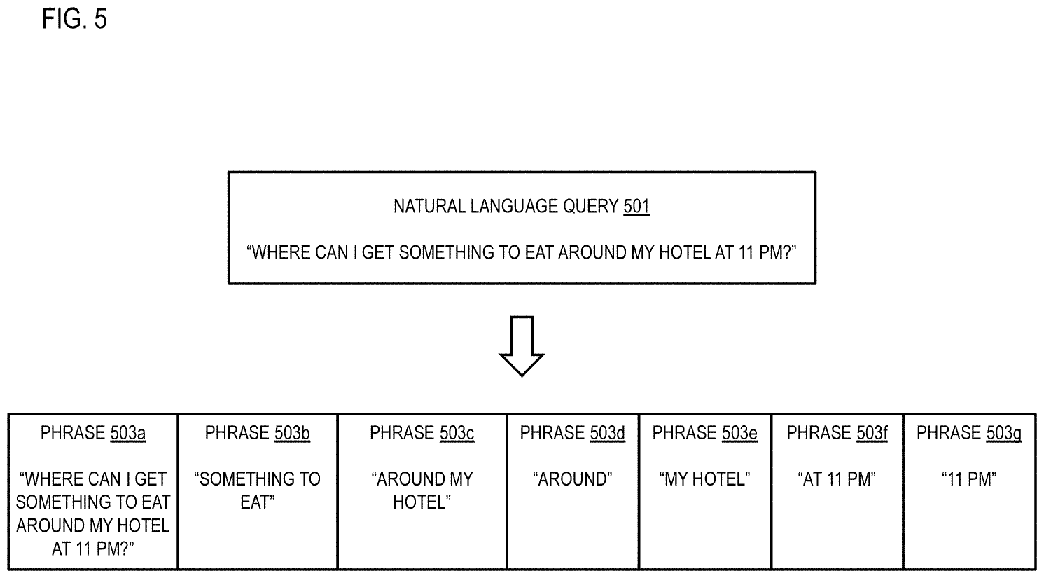

FIG. 5 is a diagram illustrating an example natural language query and a list of phrases parsed from the query, according to one embodiment. In the example of FIG. 5, the phrase splitter module 301 receives a natural language query 501 comprising “Where can I get something to eat around my hotel at 11 PM?” In one embodiment, the phrase splitting module 301 uses performs the splitting using, for instance, parts of speech detection/tagging and corresponding syntax (or any other equivalent phrase splitting algorithm). The splitting results in generating phrases 503a-503g (also collectively referred to as phrases 503) that include entire query (e.g., 503a) and then different components of the query 501 found in phrases 503b-503g.

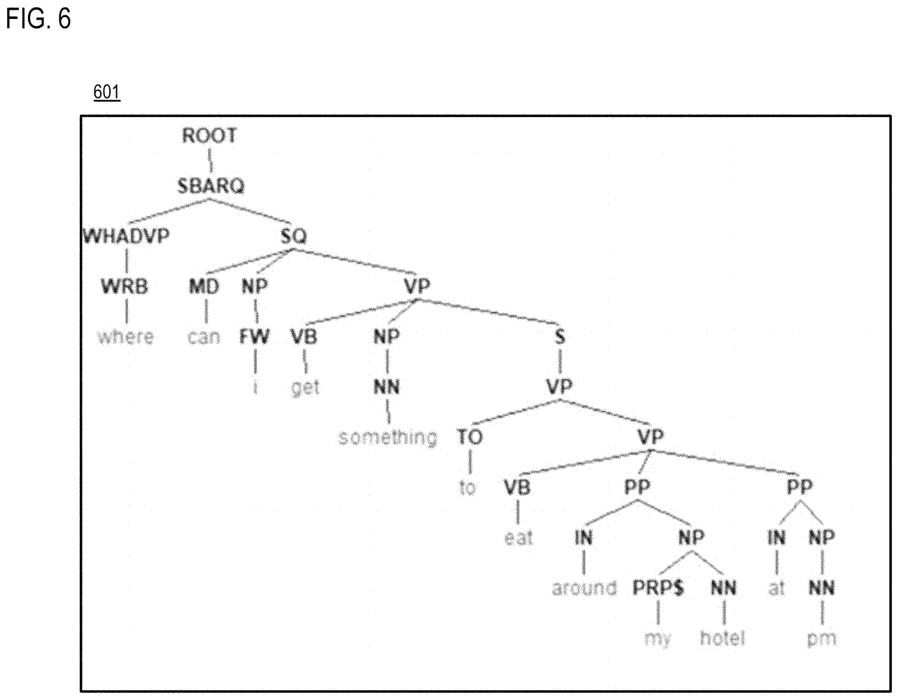

In one embodiment, the output sequence of phrases (e.g., sequence of phrases 503) is constructed by the phrase splitter module 301 which does a depth-first search on syntactically parsed results original queries 101 and extract relevant words into phrases. These extracted relevant phrases become the input of the translation machine learning model (e.g., Transformer model). In one embodiment, the phrase splitter module 301 utilizes syntactic information of words and phrases in queries. When the phrase splitter module 301 parses a natural language query 101 syntactically, the parse result forms a syntactic parse tree as shown in FIG. 6. FIG. 6 illustrates an example parse tree 601 constructed from the example natural language query 501 of FIG. 5. The acronyms and construction of the parse tree 601 is described below.

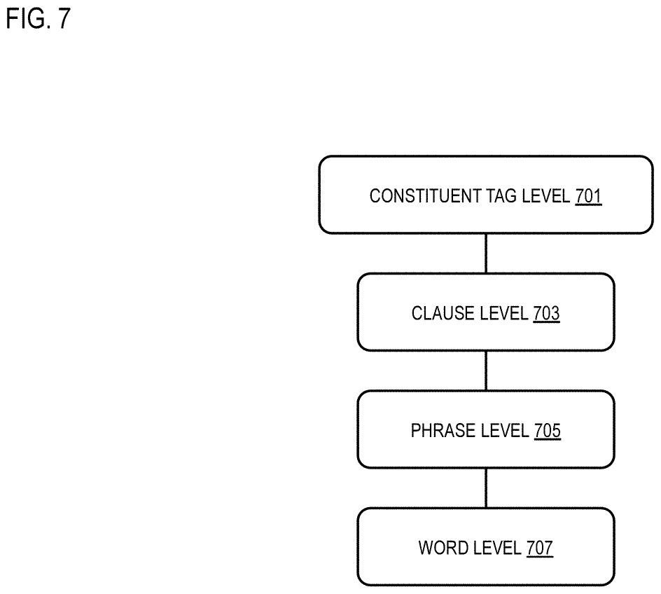

In one embodiment, the syntactic parse tree comprises, for instance, three levels of constituent tags (e.g., tags that describe or classify a type for each component parsed from a natural language query 101). For example, the parsing process generates a syntactic parse tree of the natural language query, and wherein the syntactic parse tree comprises a clause level, a phrase level, and a word level. The depth-first search on relevant phrases are based on this syntactic parse tree. FIG. 7 is a diagram illustrating an example of a constituent tag hierarchy for a syntactic parse tree, according to one embodiment. As shown, the Constituent tag hierarchy or level 701 comprises levels 703, 705, and 707. The first level is a clause level 703 comprising parsed components meeting a word length threshold that be classified as a clause (e.g., with a length threshold greater than that of a phrase threshold). The second level is a phrase level 705 comprising parsed components with more than one word but fewer than the threshold for classification as a clause). The last level is a word level 707 comprising individual words or tokens parsed from the natural language query 101.

In one embodiment, the phrase splitter module 301 focuses on the phrase level 705. In yet another embodiment, from among all phrases parsed in the phrase level 705, the phrase splitter module 301 only extracts noun phrases, adjective phrases, and/or adverb phrases. Thus, in this embodiment, the phrase splitter module 301 restricts the one or more phrases of the input query to one or more designated parts of speech (e.g., nouns, adjectives, adverbs, or any other part of speech). It is noted that the focus on phrases only is provided by way of illustration and not as a limitation. It is contemplated that the phrase splitter module 301 can select a combination of at least one phrase with one or more components or constituents of any of the clause level 703 and/or word level 707.

In one embodiment, the phrase splitter module 301 can use a designated taxonomy of the constituent tags at each level 703-707. Examples of tags and corresponding classification criteria at the clause level 703 include, but is not limited to, the examples listed in Table 1 below:

TABLE 1
CLAUSE LEVEL 703

| TAG | Description |
|---|---|
| S | Simple declarative clause, e.g., one that is not introduced by a (possible |
| | empty) subordinating conjunction or a wh-word and that does not exhibit |
| | subject-verb inversion. |
| SBAR | Clause introduced by a (possibly empty) subordinating conjunction. |
| SBARQ | Direct question introduced by a wh-word or a wh-phrase. Indirect |
| | questions and relative clauses should be bracketed as SBAR, not SBARQ |
| SINV | Inverted declarative sentence, e.g., one in which the subject follows the |
| | tensed verb or modal. |
| SQ | Inverted yes/no question, or main clause of a wh-question, following the |
| | wh-phrase in SBARQ. |

Examples of tags and corresponding classification criteria at the phrase level 705 include, but is not limited to, the examples listed in Table 2 below:

TABLE 2
PHRASE LEVEL 705

| TAG | Description |
|---|---|
| ADJP | Adjective Phrase |
| AD VP | Adverb Phrase |
| CONJP | Conjunction Phrase |
| HRAG | Fragment |
| INTJ | Interjection. Corresponds approximately to the part of speech tag UH. |
| LST | List marker. Includes surrounding punctuation. |
| NAC | Not a Constituent; used to show the scope of certain prenominal modifiers |
| | within an NP |
| NP | Noun Phrase |
| NX | Used within certain complex NPs to mark the head of the NP. Corresponds |
| | very roughly to N-bar level but used quite differently. |
| PP | Prepositional Phrase |
| PRN | Parenthetical |
| PRT | Particle. Category for words that should be tagged RP. |
| QP | Quantifier Phrase (e.g., complex measure amount phrase); used within NP |
| RRC | Reduced Relative Clause |
| UCP | Unlike Conditional Phrase |
| VP | Verb Phrase |
| WHADJP | Wh-adjective Phrase. Adjectival phrase containing a wh-adverb, as in how |
| | hot. |
| WHADVP | Wh-adverb Phrase. Introduces a clause with an NP gap. May be null or |
| | lexical, containing a wh-adverb such as how or why. |
| WHNP | Wh-noun Phrase. Introduces a clause with an NP gap. May be null or |
| | lexical, containing some wh-word, e.g., who, which book, whose daughter, |
| | none. |
| SQ | Inverted yes/no question, or main clause of a wh-question, following the |
| | wh-phrase in SBARQ. |

Examples of tags and corresponding classification criteria at the word level 707 include, but is not limited to, the examples listed in Table 1 below:

TABLE3
WORD LEVEL 707

| TAG | Description |
|---|---|
| CC | Coordinating conjunction |
| CD | Conditional number |
| DT | Determiner |
| EX | Existential there |
| FW | Foreign word |
| IN | Preposition or subordinating conjunction |
| JJ | Adjective |
| JJR | Adjective, comparative |
| JJA | Adjective, superlative |
| LS | List item marker |
| MD | Modal |
| NN | Noun, singular |
| NN$ | Noun, plural |
| NNP | Proper noun, singular |
| NNP$ | Proper noun, plural |
| PDT | Predeterminer |
| POS | Possessive ending |
| PRP | Personal pronoun |
| PRP$ | Possessive pronoun |
| RB | Adverb |
| RBR | Adverb, comparative |
| RBS | Adverb, superlative |
| RP | Particle |
| SYM | Symbol |
| TO | To |

In the example parse tree 601 of FIG. 6, the phrase splitter module has classified each word, phrase, and clause according to the constituent tags of FIG. 7. As discussed above, the phrase splitter module 301 can focus specifically on the phrases and extract the noun phrases, adjective phrases, and/or adverb phrases (or another other type of constituent clause, phrase, or word specified by the system 100). In one embodiment, the sequence of the phrases is determined by the order of the words or tokens appearing in the original natural language query from which the phrases or components were extracted.

Following the completion of step 401, the result is a sequence of phrases that can be used as an input into a machine learning model (e.g., a Transformer model) trained to translate natural language query phrases 123 to a sequence of machine executable commands and/or parameters in a service execution language. In general terms, when the input is prepared as a sequence of phrases, the Transformer model (or equivalent) predicts the output sequence given the input. In one embodiment, the output is also a sequence like the input, and the output sequence is a sequence of semantic labels corresponding to the elements or parameters values of the machine executable code 121. In other words, the one or more phrases of a natural language are parsed in a sequence (e.g., based on sentence structure or position within the query), and the resulting one or more machine executable commands and/or parameters are translated into a same-ordered sequence as the sequence of the one or more phrases. Accordingly, in step 403, the machine learning module 303 processes the one or more phrases (e.g., sequence of phrases) using a machine learning model that extracts semantic relationship information between the one or more words of the phrases and uses the semantic relationship information to translate the one or more phrases directly into one or more machine executable commands, one or more parameters of the one or more machine executable commands, or a combination thereof.

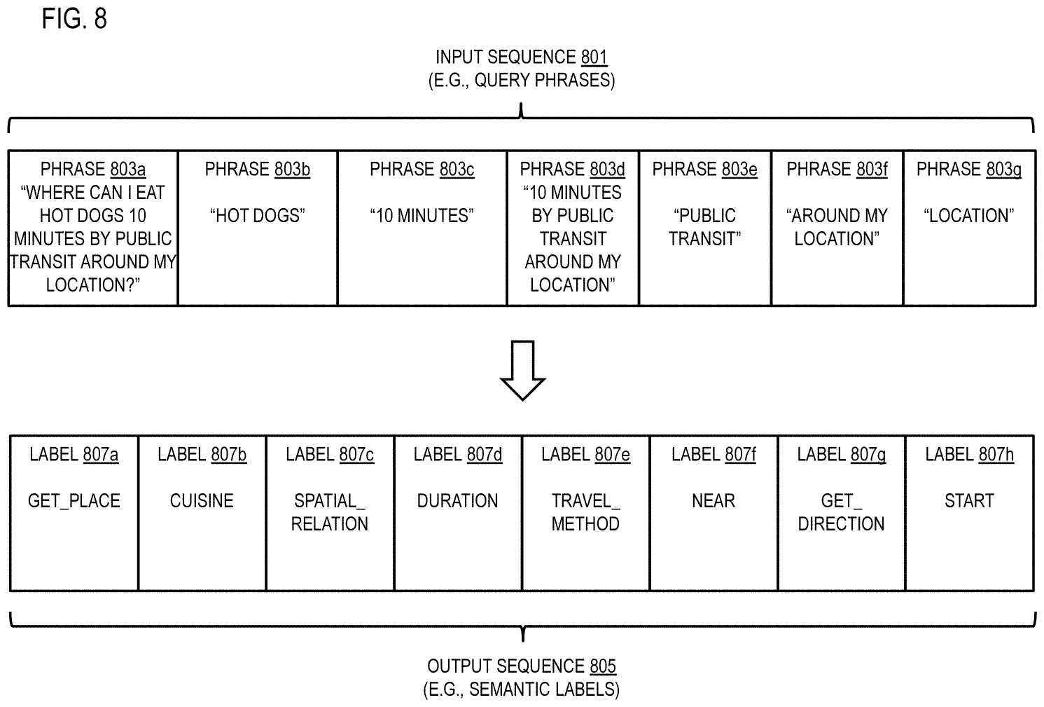

FIG. 8 is a diagram illustrating an example sequence of query phrases (e.g., input sequence 801 comprising phrases 803a-803g) and a corresponding sequence of semantic labels (e.g., output sequence 805 comprising semantic labels 807a-807h), according to one embodiment. In this example, a natural language query that asks, “Where can I eat hot dogs 10 minutes by public transit around my location?,” is input through a location-based service. The natural language query is parsed into phrases 803a-803g according to the embodiments described herein. The input sequence 801 is processed by a trained Transformer model to generate the output sequence 805 comprising semantic labels 807a-807h that correspond respectively to machine executable commands that can generate query results for the natural language query.

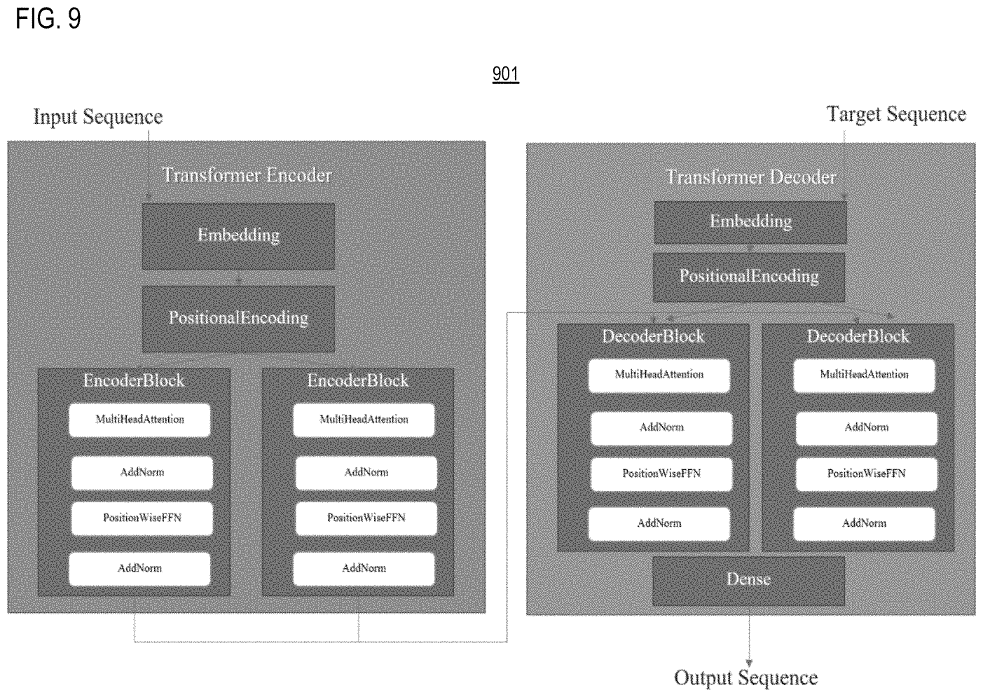

In one embodiment, the Transformer model is a type of sequence to sequence machine learning model that has multiple self-attention units in the architecture 901 of FIG. 9. The self-attention unit(s), for instance, is configured to determine or enable the determination of semantic relationship information from the query phrases. As shown, the Transformer model architecture 901 includes an encoder and decoder unit both with multi-headed attention units. Generally, the transformer encoder is configured to process the one or more phrases as an input sequence, and the transformer decoder is configured to decode the input sequence into an output sequence of one or more semantic labels corresponding to the one or more machine executable commands, the one or more parameters, or a combination thereof. For example, the encoder and decoder stacks of the Transformer model can include N blocks formed by the multi-headed Self-attention units or child layers along with feed-forward neural child networks per block. The block can also include a child network in the encoder built by a group of encoder and decoder. To optimize the Transformer network, the entire network or model can use a residual connection and applies Add and Norm to the layer. The multi-headed attention units enables the Transformer model to learn the structural semantic information between natural language phrases and the words/tokens in those phrases of the input sequence (e.g., phrases) to directly generate an output sequence of semantic labels corresponding to machine executable code in a service execution language. In some embodiment, the Transformer model can further include embeddings of input phrases that are split by the phrase splitter module 301. The embedding, for instance, is to encode the phrases that comprise more than one word into a vector by pre-trained word/text embedding machine learning models.

In other words, what the Transformer-based model does is to output the proper semantic labels (e.g., representing machine executable code) for each of the incoming query components. The way to find the proper semantic labels itself is model training. By way of example model training can use ground truth data on natural language queries and their corresponding location service calls or machine executable commands, parameters, or code. During training, a model training component feeds extracted query phrases from the natural language query into the Transformer model or equivalent to generate a corresponding sequence of semantic labels corresponding to machine executable code using an initial set of model parameters. The model training component then compares the output sequence to ground truth labels in the training data. The model training component computes a loss function representing an accuracy of the predictions for the initial set of model parameters. The model training component then incrementally adjusts the model parameters until the model minimizes the loss function (e.g., achieves a target prediction accuracy). In other words, a “trained” machine learning model for translating a natural language query to a service execution language is a machine learning model with parameters (e.g., coefficients, weights, etc.) adjusted to make accurate predictions with respect to the ground truth data.

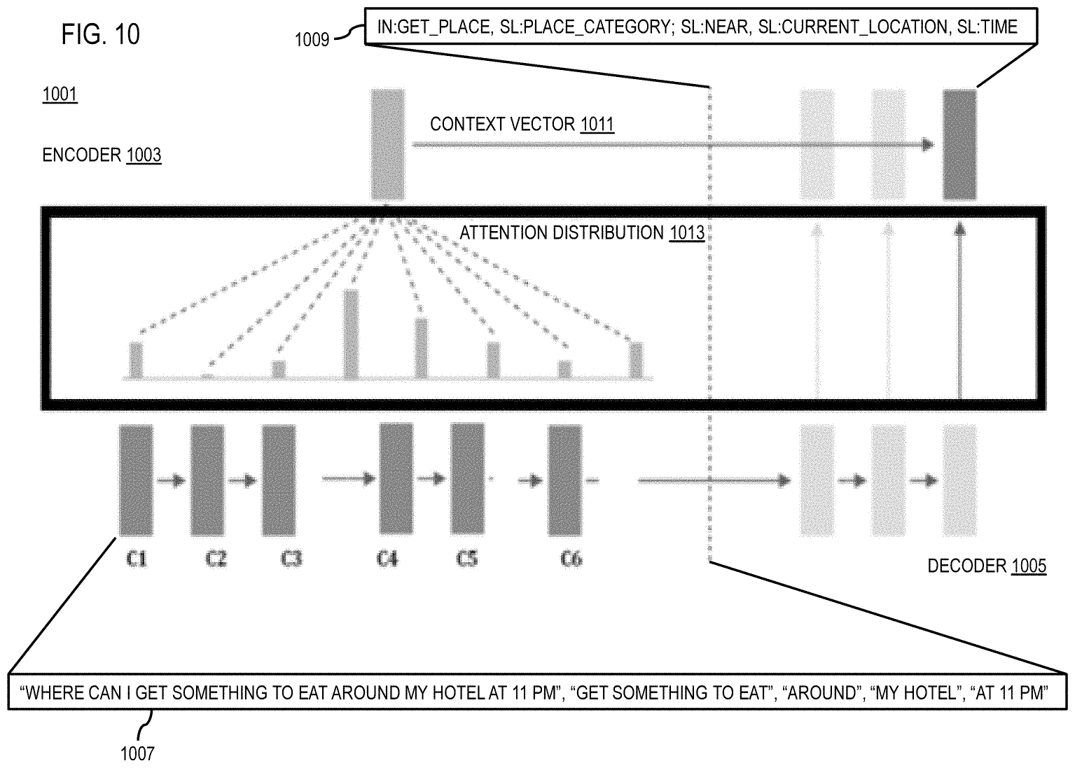

Details of architecture 901 of the Transformer model of FIG. 9 is further described with respect to FIG. 10. For example, FIG. 10 depicts a Transformer model 1001 that includes an encoder 1003 and decoder 1005 to processes the input query phrases 1007 and to generate an output 1009 of semantic labels based on a context vector 1011 (e.g., indicating the context of the query such as but not limited to a current location, time, etc.) and an attention distribution 1013. The attention distributions (e.g., attention distribution 1013) are learned parameter value distributions that are obtained during the learning/training process. These attention values imply the structural and/or semantic relationship information between input components.

After training, the Transformer model can be considered to be highly performing (e.g., able to achieve a target level of semantic labeling accuracy), the machine learning module 303 can use the trained machine learning model to get the sequence of semantic labels corresponding to a service execution language. This sequence of semantic labels comprises application, service, or machine application executable commands (e.g., machine executable code). In one embodiment, the machine executable commands or code are commands that will be executed on a service graph representing available services (e.g., services of the mapping platform 111, services platform 115, services 117, and/or content providers 119 such as but not limited to routing/navigation services, mapping services, search services, etc. In other words, the one or more machine executable commands, the one or more parameters, or a combination thereof are executed on a service graph representing one or more services of a location service platform via an application programming interface.

In one embodiment, the machine executable commands or code of the service graph can indicate which service should be called and the required parameters for the dedicated services. By way of example, the service commands (e.g., for an example service execution language) can look similar to any API call. As service graph API call, for instance, forms with two parts—(1) a service type, and (2) each service type's parameters. In some embodiments, service types can also be referred to as intent types that can be coupled with slot types or modifier types. Table 4 lists service or intent types and their parameters and Table 5 lists slot or modifier types and their parameters as follows:

```
TABLE 4
• Intent types (=Service Types)
  ○ GET_PLACE (any point of interest)
  ○ GET_AREA (includes District, Geofence)
  ○ GET_DIRECTIONS (includes Route)
  ○ GET-LOCATION (includes Address, Point on Map, Intersection)
```

```
TABLE 5
• Slot types (=Modifier Types)
  COMMON SLOTS to ALL
    ○ SPATIAL RELATION (withinInearlin), (Service)
    ○ I EMPORAL RELATION (nowItimel duration), (Service)
    ○ CONDITION: List of Descriptive Attributes
    ○ NAMED ENTITY
  PLACE:
    ○ CHAIN-Chain Name
    ○ CUISINE -Cuisine Type
    ○ CATEGORY: Category
  ○ AREA
    ○ LOCATION CATEGORY: Neighborhood | City | Named Place | Park |
    Landmark 1 Venue
  ○ DIRECTIONS ROUTE
    ○ TRAVEL METHOD
    ○ START
    ○ DESTINATION
    ○ WAYPOINT
    ○ PATH
  ○ LOCATION (Geocoordinate Base)
    ○ ADDRESS: Address
    ○ POINT ON MAP: Point
    ○ GEOHASH: Geohash such as UNL, PlusCode, What3Words
    ○ BOUNDS
      ▪ Bounds
      ▪ Point + Radius
```

Since the input query phrases and the output semantic labels are same ordered, the machine learning module 303 can represent the input and output sequences together in tree form. The service execution order of the translated machine executable commands and parameters can then be automatically extracted from the tree structure. In one embodiment, depending on the service execution language, one service call or command can include or nest other service calls inside of the outer service call. Under this embodiment, the order of execution is inner service call first and the outer service call is executed using the inner service call result.

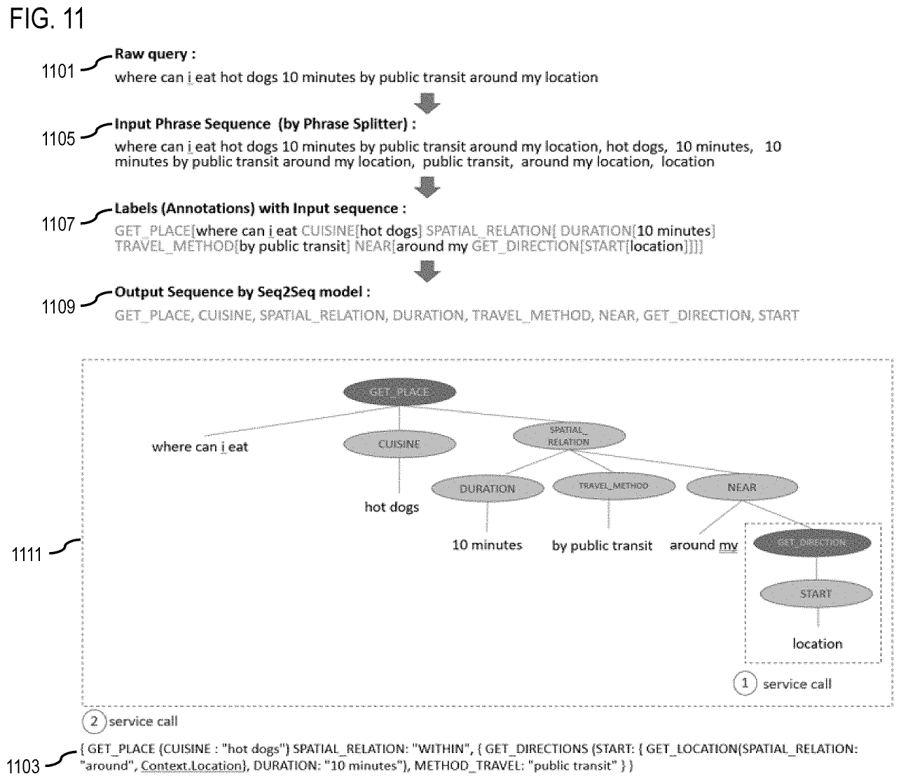

FIG. 11 is a diagram illustrating an example of query semantic parsing and service call translation, according to one embodiment. More specifically, FIG. 11 illustrates a conceptual process that approximates the functioning of the Transformer or equivalent machine learning in translating a raw natural language query 1101 to directly generate a corresponding service call 1103 (e.g., service or machine executable code). From the user standpoint, the raw query 1101 is provided and the service call 1103 is output with the processes 1105-1111 hidden in the functioning of the model. In other words, the service call 1103 (e.g., s service graph execution call in a service execution language) is composed of the parsing/translation results from the model.

On receipt of the raw national language query 1101, “wherein can I eat hot dogs 10 minutes by public transit around my location,” the phrase splitter module 301 splits the query 1101 into an input phrase sequence 1105 that can be fed into the Transformer model (e.g., sequence-to-sequence or Seq2Seq model) for translation according to the embodiments described herein. The model processes the input phrase sequence 1105 to determining semantic labels that correspond to the input sequence. The labels or annotations 1107 of the input sequence indicates semantic labels corresponding to service commands generated by the model for the corresponding input phrase.

The output sequence 1109 indicates a service execution order of the translated semantic labels or service commands. A tree 1111 of the input phrase sequence 1105 and corresponding semantic labels or annotations 1107 can be created. For example, the parameter names (e.g., selected from the intent and slot types illustrated in Tables 4 and 5) correspond to the semantic labels and the identified phrases of each semantic labels will be served as values of those parameters. The execution order of the semantic labels and the associated parameters (also extracted from the input phrase sequence 1105) are determined to generate the service call 1103 as the model output. Accordingly, throughout this procedure, the machine learning module 303 can directly translate the user queries to service call commands.]

In step 405, the output module 305 provides one or more machine executable commands, the one or more parameters, or a combination thereof as an output. For example, in some cases, the output can be saved for later execution or transmitted to a corresponding service, platform (e.g., mapping platform 111, services platform 115, etc.) for example. In one embodiment, the output module 305 interacts with the execution module 307 to initiate an execution of the one or more machine executable commands using the one or more parameters to generate a query result. The output module 305 (and/or the corresponding service that generates the query result) can provide the query result in the natural language query.

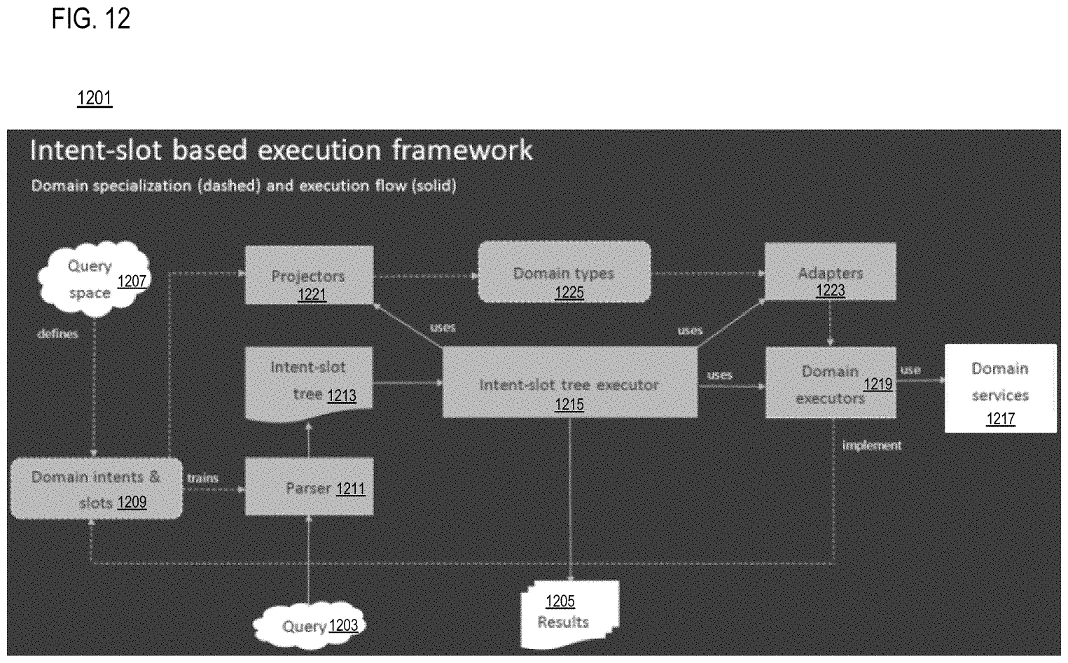

FIG. 12 is a diagram illustrating an intent-slot based execution framework, according to one embodiment. In one embodiment, the execution framework 1201 can be used by the system 100 as an end-to-end framework for managing available services (e.g., a service graph) and the translation of natural language queries 1203 for execution to generate query results 1205. The execution framework 1201, for instance, comprises a query space 1207 of all possible queries across a service graph or a group of available services for responding to the natural language query 1203. The query space 1207 can be used to define the intent and slot types 1209 (e.g., available service calls of a service execution language as illustrated in Tables 4 and 5). The intent and slot types 1209 can be defined for different service domains. In one embodiment, the query space 1207 and intent and slot types 1209 can also be used to train the parser 1211 (e.g., the parsing platform 109 and/or parsing application 107) according to the embodiment described herein. Once trained, the parser 1211 can be used to process the natural language query 1203 to generate an intent-slot tree 1213 representing a service call with corresponding service call execution order translated from the query 1203.

The resulting service call is provided to the intent-slot tree executor 1215 which then executes the service call for a given service domain. The execution of the service call can be used or directed to different domains services 1217 through respective domain executors 1219, projectors 1221, and/or adapters 1223 based on specified domain types 1225 to generate the query results 1205. The query results 1205 can then be provided in response to the initial query 1203. For example, a query 1203 that asks, “Where can I charge my electrical vehicle along my route?” will return results 1205 comprising a list of charging stations located the requestor's route.

Returning to FIG. 1, as shown, the system 100 includes a parsing platform 109 and/or parsing application 107 executing on the UE 105 for translating natural language queries to directly to a service execution language according to the various embodiments described herein. In one embodiment, the parsing platform 109 and/or parsing application 107 include or are otherwise associated with one or more machine learning models (e.g., a Transformer model or equivalent) for natural language query translation.

In one embodiment, the parsing platform 109 and/or parsing application 107 have connectivity over the communication network 127 to the services platform 115 that provides one or more services 117 that can execute machine executable commands and/or parameters translated from natural language queries to perform one or more functions. By way of example, the services 117 may be third party services and include but is not limited to mapping services, navigation services, travel planning services, notification services, social networking services, content (e.g., audio, video, images, etc.) provisioning services, application services, storage services, contextual information determination services, location based services, information based services (e.g., weather, news, etc.), etc. In one embodiment, the services 117 uses the output of the parsing platform 103 and/or parsing application 107 (e.g., machine executable code) to provide services 117 such as navigation, mapping, other location-based services, etc. to the UE 105, application 107 executing on the UE 105, and/or the like.

In one embodiment, the parsing platform 103 and/or parsing application 107 may be a platform with multiple interconnected components. The parsing platform 103 and/or parsing application 107 may include multiple servers, intelligent networking devices, computing devices, components, and corresponding software for providing place category prediction according to the various embodiments described herein. In addition, it is noted that the parsing platform 103 and/or parsing application 107 may be a separate entity of the system 100, a part of the one or more services 117, a part of the services platform 115, or included within components of the UE 105.

In one embodiment, content providers 119 may provide content or data (e.g., including natural language query or input data, geographic data, etc.) to the geographic database 113, the parsing platform 103, parsing application 107, the services platform 115, the services 117, and/or the UEs 105. The content provided may be any type of content, such as machine learning models, query data, map embeddings, map content, textual content, audio content, video content, image content, etc. In one embodiment, the content providers 119 may provide content that may aid in performing place category prediction according to the various embodiments described herein. In one embodiment, the content providers 119 may also store content associated with the geographic database 113, parsing platform 103, services platform 115, services 117, and/or any other component of the system 100. In another embodiment, the content providers 119 may manage access to a central repository of data, and offer a consistent, standard interface to data, such as a repository of the geographic database 113.

In one embodiment, the UE 105 may execute a software application 107 to translate natural language queries to a service execution language according the embodiments described herein. By way of example, the application 107 may also be any type of application that is executable on the UE 105, such as autonomous driving applications, mapping applications, location-based service applications, navigation applications, device control applications, content provisioning services, camera/imaging application, media player applications, social networking applications, calendar applications, and the like. In one embodiment, the parsing application 107 may act as a client for the parsing platform 109 and perform one or more functions alone or in combination with the parsing platform 109.

By way of example, the UE 105 is or can include any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the UE 105 can support any type of interface to the user (such as “wearable” circuitry, etc.). In one embodiment, the UE 105 may be associated with or be a component of a vehicle or any other device.

In one embodiment, the UE 105 are configured with various sensors for generating or collecting natural language query or input data (e.g., for processing by the parsing platform 103 and/or parsing application 107), related geographic data, etc. In one embodiment, the sensed data represent sensor data associated with a geographic location or coordinates at which the sensor data was collected, and the polyline or polygonal representations of detected objects of interest derived therefrom. By way of example, the sensors may include a global positioning sensor for gathering location data (e.g., GPS), IMUs, a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., the camera sensors may automatically capture road sign information, images of road obstructions, etc. for analysis), an audio recorder for gathering audio data, velocity sensors mounted on steering wheels of the vehicles, switch sensors for determining whether one or more vehicle switches are engaged, and the like.

In one embodiment, the communication network 127 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., worldwide interoperability for microwave access (WiMAX), Long Term Evolution (LTE) networks, 5G New Radio networks, code division multiple access (CDMA), wideband code division multiple access (WCDMA), wireless fidelity (Wi-Fi), wireless LAN (WLAN), Bluetooth® network, Internet Protocol (IP) data casting, satellite, mobile ad-hoc network (MANET), and the like, or any combination thereof.

By way of example, the parsing platform 109, parsing application 107, services platform 115, services 117, UE 105, and/or content providers 119 communicate with each other and other components of the system 100 using well known, new or still developing protocols. In this context, a protocol includes a set of rules defining how the network nodes within the communication network 127 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

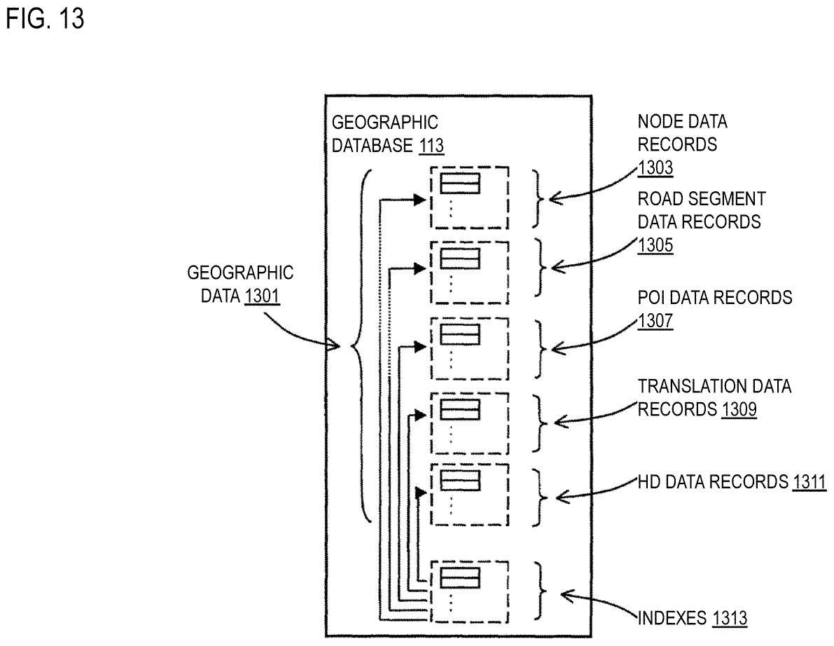

FIG. 13 is a diagram of a geographic database, according to one embodiment. In one embodiment, the geographic database 113 includes geographic data 1301 used for (or configured to be compiled to be used for) mapping and/or navigation-related services, such as for providing map embedding analytics according to the embodiments described herein. For example, the map data records stored herein can be used to determine the semantic relationships among the map features, attributes, categories, etc. represented in the geographic data 1301. In one embodiment, the geographic database 113 include high definition (HD) mapping data that provide centimeter-level or better accuracy of map features. For example, the geographic database 113 can be based on Light Detection and Ranging (LiDAR) or equivalent technology to collect billions of 3D points and model road surfaces and other map features down to the number lanes and their widths. In one embodiment, the HD mapping data (e.g., HD data records 1311) capture and store details such as the slope and curvature of the road, lane markings, roadside objects such as sign posts, including what the signage denotes. By way of example, the HD mapping data enable highly automated vehicles to precisely localize themselves on the road.

In one embodiment, geographic features (e.g., two-dimensional or three-dimensional features) are represented using polylines and/or polygons (e.g., two-dimensional features) or polygon extrusions (e.g., three-dimensional features). In one embodiment, these polylines/polygons can also represent ground truth or reference features or objects (e.g., signs, road markings, lane lines, landmarks, etc.) used for visual odometry. For example, the polylines or polygons can correspond to the boundaries or edges of the respective geographic features. In the case of a building, a two-dimensional polygon can be used to represent a footprint of the building, and a three-dimensional polygon extrusion can be used to represent the three-dimensional surfaces of the building. Accordingly, the terms polygons and polygon extrusions as used herein can be used interchangeably.

In one embodiment, the following terminology applies to the representation of geographic features in the geographic database 113.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 113 follows certain conventions. For example, links do not cross themselves and do not cross each other except at a node. Also, there are no duplicated shape points, nodes, or links. Two links that connect each other have a common node. In the geographic database 113, overlapping geographic features are represented by overlapping polygons. When polygons overlap, the boundary of one polygon crosses the boundary of the other polygon. In the geographic database 113, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 113 includes node data records 1303, road segment or link data records 1305, POI data records 1307, translation data records 1309, HD mapping data records 1311, and indexes 1313, for example. More, fewer, or different data records can be provided. In one embodiment, additional data records (not shown) can include cartographic (“carto”) data records, routing data, and maneuver data. In one embodiment, the indexes 1313 may improve the speed of data retrieval operations in the geographic database 113. In one embodiment, the indexes 1313 may be used to quickly locate data without having to search every row in the geographic database 113 every time it is accessed. For example, in one embodiment, the indexes 1313 can be a spatial index of the polygon points associated with stored feature polygons.

In exemplary embodiments, the road segment data records 1305 are links or segments representing roads, streets, or paths, as can be used in the calculated route or recorded route information for determination of one or more personalized routes. The node data records 1303 are end points (for example, representing intersections or an end of a road) corresponding to the respective links or segments of the road segment data records 1305. The road link data records 1305 and the node data records 1303 represent a road network, such as used by vehicles, cars, and/or other entities. Alternatively, the geographic database 113 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 113 can include data about the POIs and their respective locations in the POI data records 1307. The geographic database 113 can also include data about places, such as cities, towns, or other communities, and other geographic features, such as bodies of water, mountain ranges, etc. Such place or feature data can be part of the POI data records 1307 or can be associated with POIs or POI data records 1307 (such as a data point used for displaying or representing a position of a city).

In one embodiment, the geographic database 113 can also include translation data records 1309 for storing natural language queries, corresponding machine executable commands/parameters, machine learning models, service graphs, and/or any other related data that is used or generated according to the embodiments described herein.

In one embodiment, as discussed above, the HD mapping data records 1311 model road surfaces and other map features to centimeter-level or better accuracy. The HD mapping data records 1311 also include ground truth object models that provide the precise object geometry with polylines or polygonal boundaries, as well as rich attributes of the models. These rich attributes include, but are not limited to, object type, object location, lane traversal information, lane types, lane marking types, lane level speed limit information, and/or the like. In one embodiment, the HD mapping data records 1311 are divided into spatial partitions of varying sizes to provide HD mapping data to end user devices with near real-time speed without overloading the available resources of the devices (e.g., computational, memory, bandwidth, etc. resources).

In one embodiment, the HD mapping data records 1311 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the HD mapping data records 1311.

In one embodiment, the HD mapping data records 1311 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time data (e.g., including probe trajectories) also at centimeter-level accuracy. Other sensor data can include vehicle telemetry or operational data such as windshield wiper activation state, braking state, steering angle, accelerator position, and/or the like.

In one embodiment, the geographic database 113 can be maintained by the content provider 119 in association with the services platform 115 (e.g., a map developer). The map developer can collect geographic data to generate and enhance the geographic database 113. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 113 can be a master geographic database stored in a format that facilitates updating, maintenance, and development. For example, the master geographic database or data in the master geographic database can be in an Oracle spatial format or other format (e.g., that can accommodate multiple/different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF)) to organize and/or configure the data for performing navigation-related functions and/or services, such as route calculation, route guidance, map display, speed calculation, distance and travel time functions, and other functions, by a navigation device, such as by a UE 105. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for translating natural language queries to a service execution language may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

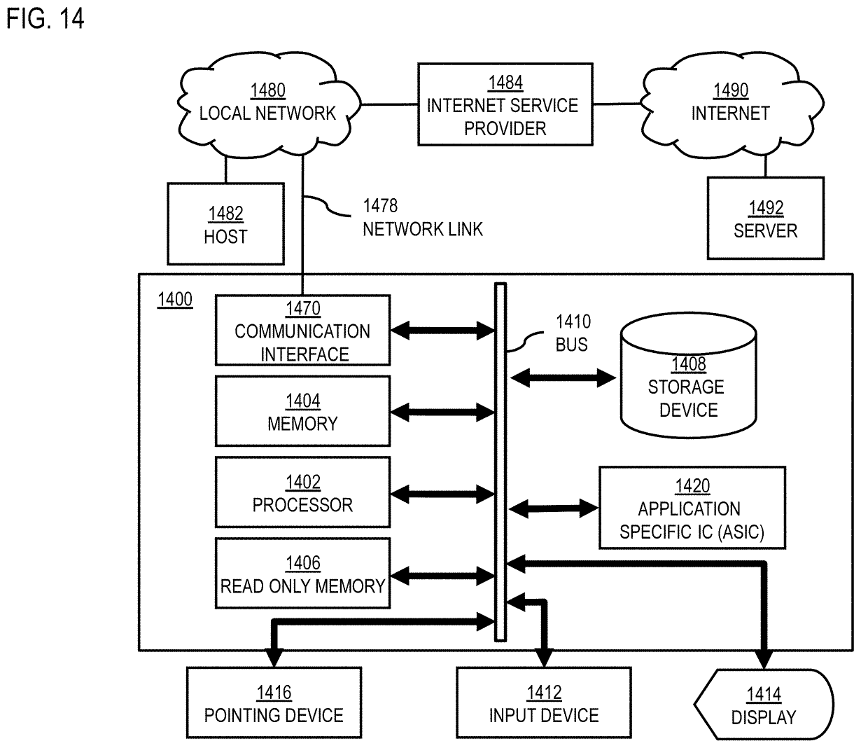

FIG. 14 illustrates a computer system 1400 upon which an embodiment of the invention may be implemented. Computer system 1400 is programmed (e.g., via computer program code or instructions) to translate natural language queries to a service execution language as described herein and includes a communication mechanism such as a bus 1410 for passing information between other internal and external components of the computer system 1400. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1410 includes one or more parallel conductors of information so that information is transferred quickly among devices coupled to the bus 1410. One or more processors 1402 for processing information are coupled with the bus 1410.

A processor 1402 performs a set of operations on information as specified by computer program code related to translating natural language queries to a service execution language. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1410 and placing information on the bus 1410. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1402, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1400 also includes a memory 1404 coupled to bus 1410. The memory 1404, such as a random access memory (RANI) or other dynamic storage device, stores information including processor instructions for translating natural language queries to a service execution language. Dynamic memory allows information stored therein to be changed by the computer system 1400. RANI allows a unit of information stored at a location called a memory address to be stored and retrieved independently of information at neighboring addresses. The memory 1404 is also used by the processor 1402 to store temporary values during execution of processor instructions. The computer system 1400 also includes a read only memory (ROM) 1406 or other static storage device coupled to the bus 1410 for storing static information, including instructions, that is not changed by the computer system 1400. Some memory is composed of volatile storage that loses the information stored thereon when power is lost. Also coupled to bus 1410 is a non-volatile (persistent) storage device 1408, such as a magnetic disk, optical disk or flash card, for storing information, including instructions, that persists even when the computer system 1400 is turned off or otherwise loses power.

Information, including instructions for translating natural language queries to a service execution language, is provided to the bus 1410 for use by the processor from an external input device 1412, such as a keyboard containing alphanumeric keys operated by a human user, or a sensor. A sensor detects conditions in its vicinity and transforms those detections into physical expression compatible with the measurable phenomenon used to represent information in computer system 1400. Other external devices coupled to bus 1410, used primarily for interacting with humans, include a display device 1414, such as a cathode ray tube (CRT) or a liquid crystal display (LCD), or plasma screen or printer for presenting text or images, and a pointing device 1416, such as a mouse or a trackball or cursor direction keys, or motion sensor, for controlling a position of a small cursor image presented on the display 1414 and issuing commands associated with graphical elements presented on the display 1414. In some embodiments, for example, in embodiments in which the computer system 1400 performs all functions automatically without human input, one or more of external input device 1412, display device 1414 and pointing device 1416 is omitted.

In the illustrated embodiment, special purpose hardware, such as an application specific integrated circuit (ASIC) 1420, is coupled to bus 1410. The special purpose hardware is configured to perform operations not performed by processor 1402 quickly enough for special purposes. Examples of application specific ICs include graphics accelerator cards for generating images for display 1414, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1400 also includes one or more instances of a communications interface 1470 coupled to bus 1410. Communication interface 1470 provides a one-way or two-way communication coupling to a variety of external devices that operate with their own processors, such as printers, scanners, and external disks. In general, the coupling is with a network link 1478 that is connected to a local network 1480 to which a variety of external devices with their own processors are connected. For example, communication interface 1470 may be a parallel port or a serial port or a universal serial bus (USB) port on a personal computer. In some embodiments, communications interface 1470 is an integrated services digital network (ISDN) card or a digital subscriber line (DSL) card or a telephone modem that provides an information communication connection to a corresponding type of telephone line. In some embodiments, a communication interface 1470 is a cable modem that converts signals on bus 1410 into signals for a communication connection over a coaxial cable or into optical signals for a communication connection over a fiber optic cable. As another example, communications interface 1470 may be a local area network (LAN) card to provide a data communication connection to a compatible LAN, such as Ethernet. Wireless links may also be implemented. For wireless links, the communications interface 1470 sends or receives or both sends and receives electrical, acoustic, or electromagnetic signals, including infrared and optical signals, that carry information streams, such as digital data. For example, in wireless handheld devices, such as mobile telephones like cell phones, the communications interface 1470 includes a radio band electromagnetic transmitter and receiver called a radio transceiver. In certain embodiments, the communications interface 1470 enables connection to the communication network 127 for translating natural language queries to a service execution language.

The term computer-readable medium is used herein to refer to any medium that participates in providing information to processor 1402, including instructions for execution. Such a medium may take many forms, including, but not limited to, non-volatile media, volatile media, and transmission media. Non-volatile media include, for example, optical or magnetic disks, such as storage device 1408. Volatile media include, for example, dynamic memory 1404.

Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization, or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 1478 typically provides information communication using transmission media through one or more networks to other devices that use or process the information. For example, network link 1478 may provide a connection through local network 1480 to a host computer 1482 or to equipment 1484 operated by an Internet Service Provider (ISP). ISP equipment 1484 in turn provides data communication services through the public, world-wide packet-switching communication network of networks now commonly referred to as the Internet 1490.

A computer called a server host 1492 connected to the Internet hosts a process that provides a service in response to information received over the Internet. For example, server host 1492 hosts a process that provides information representing video data for presentation at display 1414. It is contemplated that the components of system can be deployed in various configurations within other computer systems, e.g., host 1482 and server 1492.

FIG. 15 illustrates a chip set 1500 upon which an embodiment of the invention may be implemented. Chip set 1500 is programmed to translate natural language queries to a service execution language as described herein and includes, for instance, the processor and memory components described with respect to FIG. 14 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1500 includes a communication mechanism such as a bus 1501 for passing information among the components of the chip set 1500. A processor 1503 has connectivity to the bus 1501 to execute instructions and process information stored in, for example, a memory 1505. The processor 1503 may include one or more processing cores with each core configured to perform independently. A multi-core processor enables multiprocessing within a single physical package. Examples of a multi-core processor include two, four, eight, or greater numbers of processing cores. Alternatively or in addition, the processor 1503 may include one or more microprocessors configured in tandem via the bus 1501 to enable independent execution of instructions, pipelining, and multithreading. The processor 1503 may also be accompanied with one or more specialized components to perform certain processing functions and tasks such as one or more digital signal processors (DSP) 1507, or one or more application-specific integrated circuits (ASIC) 1509. A DSP 1507 typically is configured to process real-world signals (e.g., sound) in real time independently of the processor 1503. Similarly, an ASIC 1509 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1503 and accompanying components have connectivity to the memory 1505 via the bus 1501. The memory 1505 includes both dynamic memory (e.g., RAM, magnetic disk, writable optical disk, etc.) and static memory (e.g., ROM, CD-ROM, etc.) for storing executable instructions that when executed perform the inventive steps described herein to translate natural language queries to a service execution language. The memory 1505 also stores the data associated with or generated by the execution of the inventive steps.

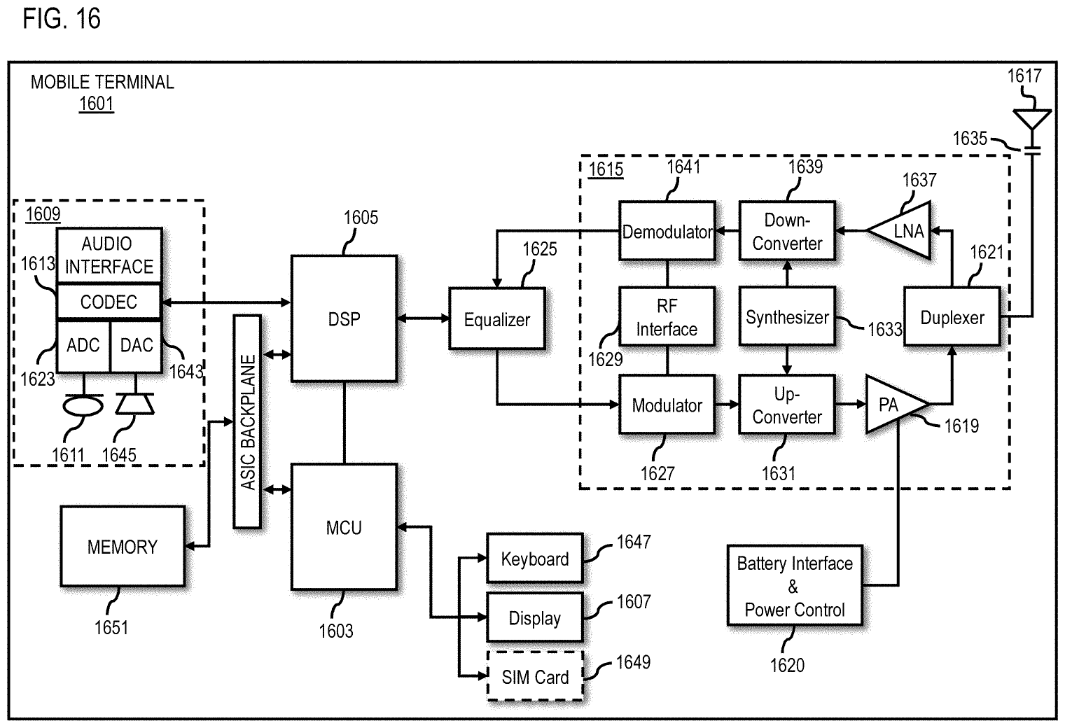

FIG. 16 is a diagram of exemplary components of a mobile terminal 1601 (e.g., handset or other device) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1603, a Digital Signal Processor (DSP) 1605, and a receiver/transmitter unit including a microphone gain control unit and a speaker gain control unit. A main display unit 1607 provides a display to the user in support of various applications and mobile station functions that offer automatic contact matching. An audio function circuitry 1609 includes a microphone 1611 and microphone amplifier that amplifies the speech signal output from the microphone 1611. The amplified speech signal output from the microphone 1611 is fed to a coder/decoder (CODEC) 1613.

A radio section 1615 amplifies power and converts frequency in order to communicate with a base station, which is included in a mobile communication system, via antenna 1617. The power amplifier (PA) 1619 and the transmitter/modulation circuitry are operationally responsive to the MCU 1603, with an output from the PA 1619 coupled to the duplexer 1621 or circulator or antenna switch, as known in the art. The PA 1619 also couples to a battery interface and power control unit 1620.

In use, a user of mobile station 1601 speaks into the microphone 1611 and his or her voice along with any detected background noise is converted into an analog voltage. The analog voltage is then converted into a digital signal through the Analog to Digital Converter (ADC) 1623. The control unit 1603 routes the digital signal into the DSP 1605 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UNITS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1625 for compensation of any frequency-dependent impairments that occur during transmission though the air such as phase and amplitude distortion. After equalizing the bit stream, the modulator 1627 combines the signal with a RF signal generated in the RF interface 1629. The modulator 1627 generates a sine wave by way of frequency or phase modulation. In order to prepare the signal for transmission, an up-converter 1631 combines the sine wave output from the modulator 1627 with another sine wave generated by a synthesizer 1633 to achieve the desired frequency of transmission. The signal is then sent through a PA 1619 to increase the signal to an appropriate power level. In practical systems, the PA 1619 acts as a variable gain amplifier whose gain is controlled by the DSP 1605 from information received from a network base station. The signal is then filtered within the duplexer 1621 and optionally sent to an antenna coupler 1635 to match impedances to provide maximum power transfer. Finally, the signal is transmitted via antenna 1617 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1601 are received via antenna 1617 and immediately amplified by a low noise amplifier (LNA) 1637. A down-converter 1639 lowers the carrier frequency while the demodulator 1641 strips away the RF leaving only a digital bit stream. The signal then goes through the equalizer 1625 and is processed by the DSP 1605. A Digital to Analog Converter (DAC) 1643 converts the signal and the resulting output is transmitted to the user through the speaker 1645, all under control of a Main Control Unit (MCU) 1603—which can be implemented as a Central Processing Unit (CPU) (not shown).

The MCU 1603 receives various signals including input signals from the keyboard 1647. The keyboard 1647 and/or the MCU 1603 in combination with other user input components (e.g., the microphone 1611) comprise a user interface circuitry for managing user input. The MCU 1603 runs a user interface software to facilitate user control of at least some functions of the mobile station 1601 to translate natural language queries to a service execution language. The MCU 1603 also delivers a display command and a switch command to the display 1607 and to the speech output switching controller, respectively. Further, the MCU 1603 exchanges information with the DSP 1605 and can access an optionally incorporated SIM card 1649 and a memory 1651. In addition, the MCU 1603 executes various control functions required of the station. The DSP 1605 may, depending upon the implementation, perform any of a variety of conventional digital processing functions on the voice signals. Additionally, DSP 1605 determines the background noise level of the local environment from the signals detected by microphone 1611 and sets the gain of microphone 1611 to a level selected to compensate for the natural tendency of the user of the mobile station 1601.

The CODEC 1613 includes the ADC 1623 and DAC 1643. The memory 1651 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1651 may be, but not limited to, a single memory, CD, DVD, ROM, RAM, EEPROM, optical storage, or any other non-volatile or non-transitory storage medium capable of storing digital data.

An optionally incorporated SIM card 1649 carries, for instance, important information, such as the cellular phone number, the carrier supplying service, subscription details, and security information. The SIM card 1649 serves primarily to identify the mobile station 1601 on a radio network. The card 1649 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method for translating a natural language query into one or more machine executable commands comprising:
parsing the natural language query into one or more phrases respectively comprising one or more words of the natural language query;
processing the one or more phrases using a machine learning model that extracts semantic relationship information between the one or more words and uses the semantic relationship information to translate the one or more phrases directly into one or more machine executable commands, one or more parameters of the one or more machine executable commands, or a combination thereof; and
providing the one or more machine executable commands, the one or more parameters, or a combination thereof as an output.

2. The method of claim 1, wherein the one or more one or more machine executable commands are location service commands.

3. The method of claim 1, wherein the one or more phrases are parsed in a sequence, and wherein the one or more machine executable commands, the one or more parameters, or a combination thereof are translated into a same-ordered sequence as the sequence of the one or more phrases.

4. The method of claim 1, wherein the parsing restricts the one or more phrases to one or more designated parts of speech.

5. The method of claim 4, wherein the one or more designated parts of speech include a noun phrase, an adjective phrase, an adverb phrase, or a combination thereof.

6. The method of claim 1, wherein the parsing generates a syntactic parse tree of the natural language query, and wherein the syntactic parse tree comprises a clause level, a phrase level, and a word level.

7. The method of claim 6, further comprising:
performing a depth-first search of the syntactic parse tree to determine the one or more phrases.

8. The method of claim 1, wherein the machine learning model is a transformer model comprising:
a transformer encoder configured to process the one or more phrases as an input sequence; and
a transformer decoder configured to decode the input sequence into an output sequence of one or more semantic labels corresponding to the one or more machine executable commands, the one or more parameters, or a combination thereof.

9. The method of claim 8, wherein the transformer model includes at least one self-attention unit, and wherein the at least one self-attention unit is configured to determine the semantic relationship information.

10. The method of claim 1, further comprising:
determining a service execution order based on a sequence order of the one or more machine executable commands, the one or more parameters, or a combination thereof.

11. The method of claim 1, further comprising:
initiating an execution of the one or more machine executable commands using the one or more parameters to generate a query result; and
providing the query result in response to the natural language query.

12. The method of claim 1, wherein the one or more machine executable commands, the one or more parameters, or a combination thereof are executed on a service graph representing one or more services of a location service platform via an application programming interface.

13. An apparatus for translating a natural language input into one or more machine executable commands comprising:
at least one processor; and
at least one memory including computer program code for one or more programs, the at least one memory and the computer program code configured to, with the at least one processor, cause the apparatus to perform at least the following,
parsing the natural language input into one or more phrases respectively comprising one or more words of the natural language input;
processing the one or more phrases using a machine learning model that extracts semantic relationship information between the one or more words and uses the semantic relationship information to translate the one or more phrases directly into one or more machine executable commands, one or more parameters of the one or more machine executable commands, or a combination thereof; and
providing the one or more machine executable commands, the one or more parameters, or a combination thereof as an output.

14. The apparatus of claim 13, wherein the one or more machine executable commands are location service commands.

15. The apparatus of claim 13, wherein the one or more phrases are parsed in a sequence, and wherein the one or more machine executable commands, the one or more parameters, or a combination thereof are translated into a same-ordered sequence as the sequence of the one or more phrases.

16. The apparatus of claim 13, wherein the parsing restricts the one or more phrases to one or more designated parts of speech.

17. A non-transitory computer-readable storage medium for translating a natural language query into one or more machine executable commands carrying one or more sequences of one or more instructions which, when executed by one or more processors, cause an apparatus to at least perform the following steps:
parsing the natural language query into one or more phrases respectively comprising one or more words parsed from the natural language query;
processing the one or more phrases using a machine learning model that extracts semantic relationship information between the one or more words and uses the semantic relationship information to translate the one or more phrases directly into one or more machine executable commands, one or more parameters of the one or more machine executable commands, or a combination thereof; and
initiating an execution of the one or more machine executable commands, the one or more parameters, or a combination thereof to generate a query result.

18. The non-transitory computer-readable storage medium of claim 17, wherein the one or more one or more machine executable commands are location service commands.

19. The non-transitory computer-readable storage medium of claim 17, wherein the one or more phrases are parsed in a sequence, and wherein the one or more machine executable commands, the one or more parameters, or a combination thereof are translated into a same-ordered sequence as the sequence of the one or more phrases.

20. The non-transitory computer-readable storage medium of claim 17, wherein the parsing restricts the one or more phrases to one or more designated parts of speech.
